(19) United States
(12) Patent Application Publication
(10) Pub. No.: US 2010/0124350 A1
(43) Pub. Date: May 20, 2010

(54) WALL ELEMENT WITH A SOUND GENERATOR

(76) Inventor: Markus Militzer, Pfullingen (DE)

Correspondence Address: Striker, Striker & Stenby, 103 East Neck Road, Huntington, NY, 11743, US

(21) Appl. No.: 12/616,840

(22) Filed: Nov. 12, 2009

(30) Foreign Application Priority Data
Nov. 18, 2008 (DE) 10 2008 058 095.3

(51) Int. Cl. H04R 1/02; E04B 1/82

(52) U.S. Cl. 381/386; 181/284

(57) ABSTRACT

A wall element, in particular of an exhibit booth, includes at least one sound generator that is integrated in the wall element and is not visible from the outside.

### CROSS-REFERENCE TO A RELATED APPLICATION

The invention described and claimed hereinbelow is also described in German Patent Application DE 10 2008 058 095.3 filed on Nov. 18, 2008. This German Patent Application, whose subject matter is incorporated here by reference, provides the basis for a claim of priority of invention under 35 U.S.C. 119(a)-(d).

### BACKGROUND OF THE INVENTION

The present invention relates to a wall element, in particular of an exhibit booth.

Wall elements are used in exhibits or museums, and at trade shows for presenting and visually transmitting certain information. In the case of presentation walls in museums in particular, it is known to install loudspeakers on the presentation walls or in their vicinity, in order to also transmit acoustic information. These loudspeakers are visible from the outside and impair the overall visual appearance of the wall element. In addition, in particular, the surfaces covered by the loudspeakers are unusable as presentation surfaces.

An acoustic wall in which a loudspeaker is integrated is made known in DE 34 02 967 A1. The control of the loudspeaker is not depicted or described.

DE 10 2008 018 110 A1 discloses a component that includes an integrated ultrasound sensor.

EP 1 276 092 B1 describes a display case that includes a motion sensor; when a visitor approaches the display case, he is prompted to provide manual input in order to display additional information. The display case may also contain a loudspeaker.

### SUMMARY OF THE INVENTION

The object of the present invention is to provide a wall element which may be used to output acoustic information in an unseen manner.

In keeping with these objects and with others which shall become apparent hereafter, one feature of the present invention resides, briefly stated, in a wall element comprising at least one sound generator integrated in the wall element and not visible from an outside; at least one sensor activating a sound output via said at least one sound generator; and a playback device connected to said at least one sound generator, wherein said at least one sensor is connected to said playback device.

The side of the wall element that is visible to a visitor is therefore not interrupted by a loudspeaker. The surface of the wall element may be designed in entirety and used to transmit information. Distracting loudspeakers or loudspeaker covers that extend partially outward are not present, thereby resulting in a greatly improved visual appearance of the wall element. Yet, acoustic information may still be communicated to a visitor standing in front of the wall element.

Particularly preferably, the wall element includes a front panel and a rear panel, and the at least one sound generator is located between the panels. As a result, the sound generator is situated in a protected manner, and it is invisible from the outside. The panels may be designed as particle-board panels. However, other types of panels are also feasible, such as MDF panels or the like.

A particularly simple means of installing the sound generator results when it is mounted on one of the panels. Via this measure it is also possible for sound waves to be transmitted from the sound generator to the panel, and so the panel thereby serves more or less as a resonance body.

According to an embodiment of the present invention, it may be provided that the sound generator includes a diaphragm. This diaphragm of the sound generator may be set into oscillating motion, thereby making it possible to transmit acoustic information. In a panel loudspeaker, the surface functions more or less as a diaphragm.

The diaphragm may be welded or bonded to the sound generator. In a panel loudspeaker, the panel and the sound generator are preferably bonded to one another.

According to a particularly preferred embodiment of the present invention, a plurality of sound generators may be provided. These sound generators may be connected to one another in series or in parallel, and they may be located at different levels in the wall element, thereby ensuring that visitors of different heights may also clearly understand the sound and language.

At least one sensor is provided to activate the sound output via the at least one sound generator. The start of the sound output may therefore be controlled by a visitor.

The sensors may be located on the outside, on the wall element, or they may be located inside the wall element, between the panels. This design has the advantage that the sensors likewise do not detract from the appearance of the wall element. In addition, the sensors are safe from damage by the visitors.

Highly diverse types of sensors are feasible for use as the sensors. For example, touch sensors or radar sensors, motion sensors, or the like may be used. If the sensor is designed as a touch sensor, a touch-sensitive sensor surface may be located on one of the panels of the wall element. If the sensor is designed as a motion sensor, the sound output may be started automatically when a visitor approaches the wall element.

A playback device that is connected to the at least one sound generator is provided. Preferably, one or more sound files may be stored in the playback device. In particular, the playback device may be designed as a flash player.

In a particularly preferred embodiment, it may be provided that the playback device is also integrated in the wall element. This is not visible from the outside to a visitor, either. The playback device is also protected, since it is located between the panels of the wall element.

The at least one sensor is connected to the playback device. In particular, a plurality of sensors may be connected in parallel to the playback device. The playback device may therefore be activated by a sensor, and so sound is output via one or more of the sound generators.

In an advantageous embodiment of the wall element, it may be provided that the at least one sound generator is at least partially enclosed in a sound-absorbing material, in particular a sound-absorbing foam. The foam may improve the sound quality.

Honeycombs made of cardboard may be located between the panels for stiffening purposes. This makes it possible to design the wall elements to have inherent stiffness.

They are therefore self-supporting and stable.

Further features and advantages of the present invention result from the detailed description of embodiments of the present invention that follows, with reference to the figures in the drawing which shows the details that are essential to the present invention. Further features and advantages of the present invention also result from the claims. The features described therein are not intended to be interpreted literally, and are presented in such a manner that the special features of the present invention may be presented clearly. The various features may be realized individually, or they may be combined in any possible manner in different variations of the present invention.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 shows a top view of a wall element according to the present invention, with the rear panel removed;

FIG. 2 shows a partial cross-sectional view of the wall element in the region of a sound generator;

FIG. 3 shows a partial cross-sectional view of the wall element in the region of sensors.

### DESCRIPTION OF THE PREFERRED EMBODIMENTS

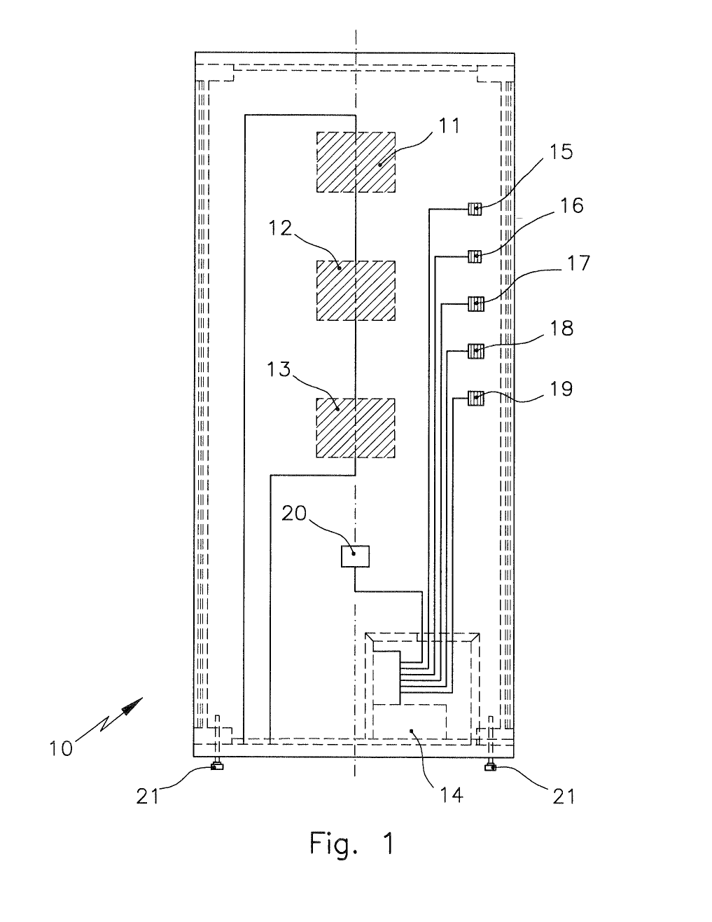

FIG. 1 shows a wall element 10 which, in the embodiment, includes three sound generators 11, 12, 13. Sound generators 11, 12, 13 are connected in series and are connected to a playback device 14 which is designed as a flash player. Five touch sensors 15 through 19 and a radar sensor 20 are connected to playback device 14. Radar sensor 20 may be used to detect when a visitor is approaching wall element 10. In response thereto, playback device 14 may be activated, and so sound is output via sound generators 11 through 13.

If the visitor is standing in front of wall element 10, he may touch one of the touch sensors 15 through 19 and/or assigned touch surfaces, thereby activating sound output by playback device 14 via sound generators 11 through 13. Feet 21, 22 are provided on the bottom of wall element 10, thereby making it possible for wall element 10 to be used in a wall system, in particular of an exhibit booth.

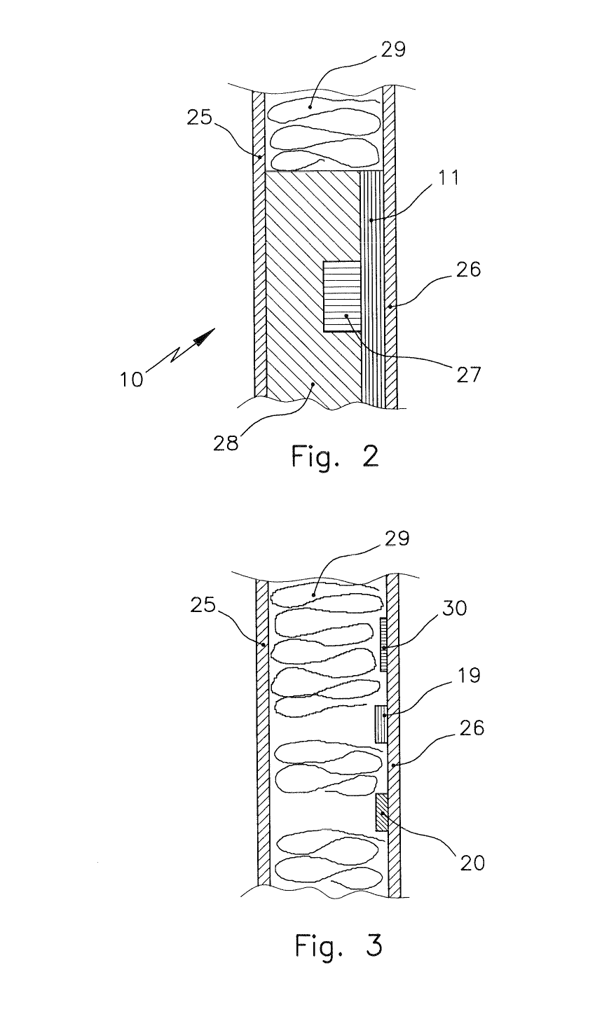

FIG. 2 shows the design of wall element 10. Wall element 10 includes a back panel 25 and a front panel 26. Sound generator 11 is located between panels 25, 26. In particular, sound generator 11 is connected to panel 26. Sound generator 11 includes a diaphragm 27 that is bonded to the rest of sound generator 11, and is enclosed in a sound-absorbing material 28, in particular in a sound-absorbing foam. Sound-absorbing material 28 fills the space between panels 25, 26 in the region of sound generator 11. Honeycombs 29 composed of cardboard are located between panels 25, 26, above sound generator 11.

FIG. 3 shows a further cross-sectional view of wall element 10, in which it is shown that sensor 19 and contact surface 30 assigned to it, and radar sensor 20 are located and/or mounted on panel 26. It is also shown that the space between panels 25, 26 is filled with honeycombs 29 composed of cardboard.

It will be understood that each of the elements described above, or two or more together, may also find a useful application in other types of constructions differing from the types described above.

While the invention has been illustrated and described as embodied in a wall element with a sound generator, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A wall element comprising at least one sound generator integrated in the wall element and not visible from an outside; at least one sensor activating a sound output via said at least one sound generator; and a playback device connected to said at least one sound generator, wherein said at least one sensor is connected to said playback device.

2. The wall element as defined in claim 1, wherein the wall element is a wall element of an exhibit booth.

3. The wall element as defined in claim 1, further comprising a front panel and a rear panel, wherein at least one sound generator is located between said front panel and said real panel.

4. The wall element as defined in claim 3, wherein said sound generator is fastened to one of said panels.

5. The wall element as defined in claim 1, wherein said sound generator includes a diaphragm.

6. The wall element as defined in claim 1, wherein a plurality of said sound generators are provided.

7. The wall element as defined in claim 1, wherein said sensor is a sensor selected from the group consisting of a touch sensor, a radar sensor, and a motion sensor.

8. The wall element as defined in claim 1, wherein said playback device is also integrated in the wall element.

9. The wall element as defined in claim 1, further comprising a sound-absorbing material, wherein said at least one sound generator is at least partially enclosed in said sound-absorbing material.

10. The wall element as defined in claim 9, wherein said sound-absorbing material is a foam.

11. The wall element as defined in claim 2, further comprising honeycombs composed of cardboard and located between said panels.

12. The wall element as defined in claim 1, wherein the wall element is configured to have inherent stiffness.
